(19) United States
(12) Patent Application Publication
(10) Pub. No.: US 2026/0279407 A1
(43) Pub. Date: Sep. 17, 2026

(54) HARD DISK DRIVE COVER AND ENVIRONMENTAL CONTROL MODULE

(71) Applicant: SEAGATE TECHNOLOGY LLC, Fremont, CA (US)

(72) Inventors: Patrick M. Thomas, Lyons, CO (US); Akihiko Ohnaka, Longmont, CO (US); Henry Isaiah Kussin-Bordo, Broomfield, CO (US); Brian D. Adler, Longmont, CO (US); Paul A. Beatty, Fort Collins, CO (US)

(21) Appl. No.: 19/555,058

(22) Filed: Mar. 3, 2026

Related U.S. Application Data
(60) Provisional application No. 63/773,221, filed on Mar. 17, 2025.

(51) Int. Cl. G11B 33/14

(52) U.S. Cl. CPC G11B 33/14

(57) ABSTRACT

Systems, methods, and devices include a hard disk drive with an environmental control module (or ECM) positioned between two covers of a hard disk drive. The environmental control module can include a desiccant and/or a filter that help control environmental conditions within an internal cavity of the hard disk drive.

### RELATED APPLICATIONS

This application claims priority to U.S. Provisional Patent Application No. 63/773,221, filed on Mar. 17, 2025, which is hereby incorporated by reference herein for all purposes.

### SUMMARY

In certain embodiments, a hard disk drive includes a base deck, a first cover coupled to the base deck, a second cover coupled to the base deck, and an environmental control module positioned between the second cover and at least a portion of the first cover.

In certain embodiments, a method includes coupling a first cover to a base deck of a hard disk drive, positioning an environmental control module on a portion of the first cover, and enclosing the environmental control module by securing a second cover to the base deck.

In certain embodiments, an environmental control module includes a metal casing that encloses a desiccant. The metal casing can also enclose a plastic film or sheet. The metal casing can be punctured to exposure the desiccant to moisture.

While multiple embodiments are disclosed, still other embodiments of the present disclosure will become apparent to those skilled in the art from the following detailed description, which shows and describes illustrative embodiments. Accordingly, the drawings and detailed description are to be regarded as illustrative in nature and not restrictive.

### BRIEF DESCRIPTION OF THE DRAWINGS

FIG. 1 shows a side sectional view of an exemplary hard disk drive.

FIG. 2 shows a partially exploded view of a hard disk drive, in accordance with certain embodiments of the present disclosure.

FIG. 3 shows a partial side sectional schematic view of the hard disk drive, in accordance with certain embodiments of the present disclosure.

FIG. 4 is a flowchart showing a method of assembling the hard disk drive, in accordance with certain embodiments of the present disclosure.

While the disclosure is amenable to various modifications and alternative forms, specific embodiments have been shown by way of example in the drawings and are described in detail below. The intention, however, is not to limit the disclosure to the particular embodiments described but instead is intended to cover all modifications, equivalents, and alternatives falling within the scope of the appended claims.

### DETAILED DESCRIPTION

Certain embodiments of the present disclosure are directed to methods and devices that feature a cover that is shaped to accommodate (or otherwise support) an environmental control module (ECM) for a hard disk drive. The ECM can include components such as a desiccant and/or filter and can help control environmental factors (e.g., humidity levels, contamination concentration, and/or oxygen levels) within the hard disk drive.

In general, a hard disk drive is an electromechanical device comprising an enclosure that stores and retrieves digital information (data) by using a plurality of data storage components, including magnetic recording media, a spindle motor, a pivot bearing, a suspension element, and/or a plurality of read/write heads, as will be further discussed herein. Various environmental factors can affect the function of the hard disk drive. For example, humidity, chemical contaminants (e.g., volatile organic compounds), and an undesired level of oxygen in the hard disk drive may affect data storage components and degrade performance of the hard disk drive over time.

To help manage or control the environmental conditions within the enclosure of the hard disk drive, the enclosure can be sealed. Sealing helps reduce the risk of external environmental conditions (e.g., ambient moisture or airborne particles) from influencing performance of the hard disk drive. Additionally, the hard disk drive may use an ECM within the sealed environment. The ECM can include one or more environmental control components configured to help manage environmental conditions (e.g., humidity, chemical contaminant concentration, oxygen levels) within the enclosure of the hard disk drive. However, the ECM itself may utilize materials that themselves outgas chemical contaminants.

Certain embodiments of the present disclosure are accordingly directed to approaches that utilize a portion of a cover of a hard disk drive to house environmental control components. Using such approaches, the environmental control components can be supported using the structure of the cover—which can reduce the need to use materials (such as a plastic housing) to provide a supportive structure.

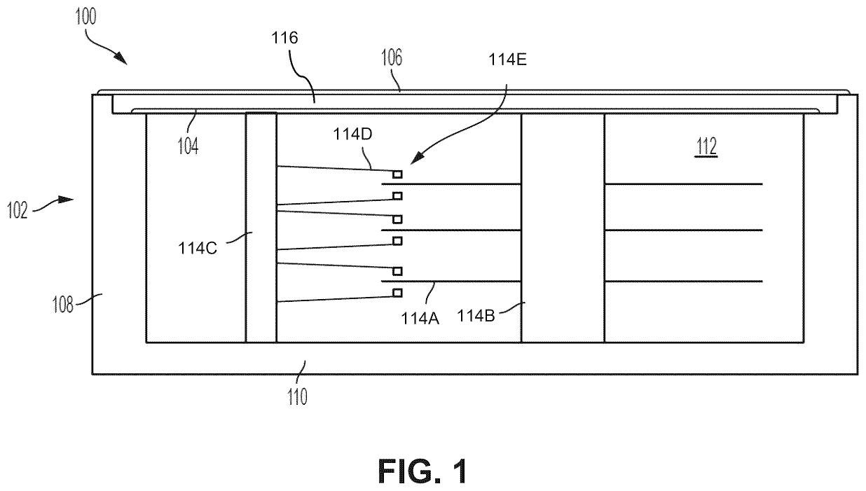

FIG. 1 shows a side sectional view of an exemplary hard disk drive 100. The hard disk drive 100 may be a heat-assisted magnetic recording (HAMR) drive; however, other known types of hard disk drives may be used such as those considered to be conventional magnetic recording (CMR) drives. The hard disk drive 100 includes a base deck 102, a first (e.g., “process”) cover 104, and a second (e.g., “final”) cover 106. The base deck 102 includes a bottom portion 110 and a sidewall 108 extending substantially upward therefrom. The sidewall 108 is coupled to both the process cover 104 and the final cover 106.

The base deck 102 defines an enclosure having a first internal cavity 112 and a second internal cavity 116. More specifically, the bottom portion 110, sidewall 108, and process cover 104 may define first internal cavity 112. The sidewall 108, process cover 104, and final cover 106 may define the second internal cavity 116. In some embodiments, the first and second internal cavities 112, 116 are not fully sealed from each other so as to allow fluid communication between each cavity 112, 116. In such embodiments, the first and second internal cavities 112, 116 effectively become a single internal cavity within the base deck 102, where the second internal cavity 116 defines a top portion between the final cover 106 and process cover 104 and the first internal cavity 112 defines a bottom portion between the process cover 104 and the bottom portion 110.

As shown, the first internal cavity 112 may house a plurality of data storage components 114 including but not limited to, for example, magnetic recording media 114A, a spindle motor 114B, an actuator pivot bearing 114C, suspensions 114D, and read/write heads 114E, or other components. In certain embodiments, such as the illustrated embodiment in FIG. 1, the spindle motor 114B and the actuator pivot bearing 114C are coupled between the process cover 104 and the bottom portion 110 of the base deck 102. Any type, quantity, or relative positioning of each of the plurality of data storage components 114 may be considered to meet the needs of a specific design application without extending beyond the scope of the present disclosure. As such, the plurality of data storage components 114 as shown in FIG. 1 should be construed as exemplary and do not limit the scope of the present disclosure.

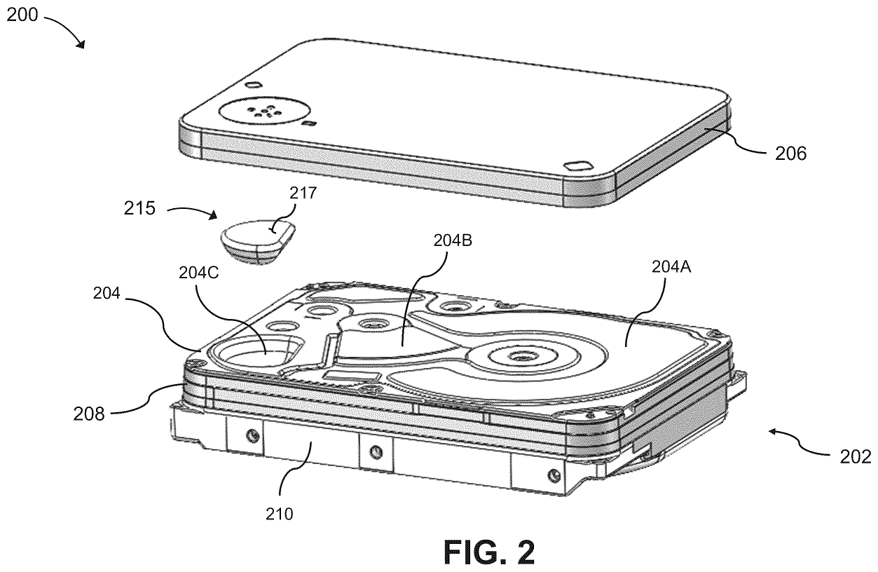

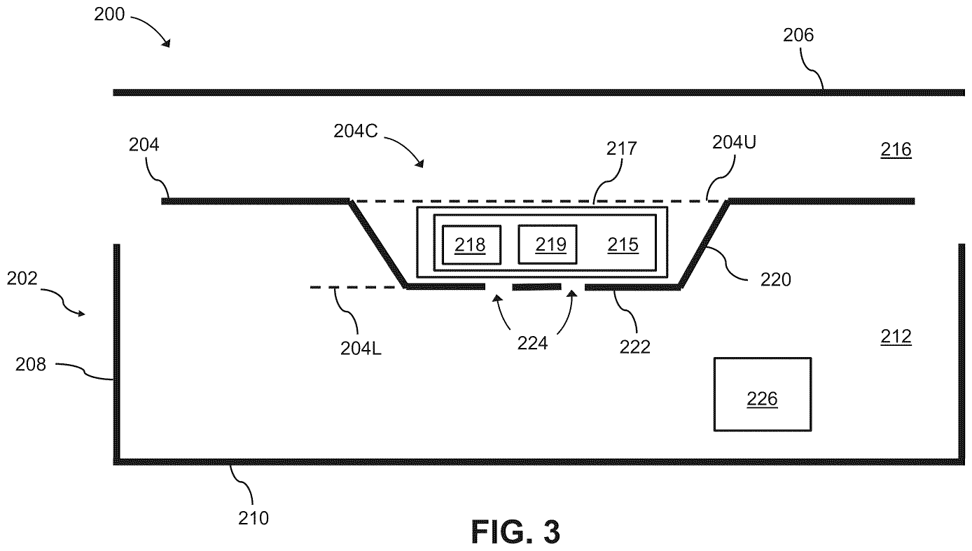

Turning to FIG. 2, a partially exploded view of a hard disk drive 200 is shown, in accordance with certain embodiments of the present disclosure. For brevity, components of hard disk drive 200 of FIG. 2 that are similar to the hard disk drive 100 of FIG. 1 will have the same reference number, preceded by a “2.” For example, the hard disk drive 200 comprises a base deck 202, a process cover 204, and a final cover 206. The base deck 202 includes a sidewall 208 that, together with a bottom portion 210 of the base deck 202 and the process cover 204, define a first internal cavity 212 (shown in FIG. 3). The first internal cavity 212 houses data storage components such as those previously described herein. The base deck 202 may additionally include fasteners to facilitate coupling and sealing of the process cover 204 to the base deck 202.

The process cover 204 may comprise various sections or portions that, when coupled to the base deck 202, roughly correspond to the position of associated data storage components 214 positioned within the first internal cavity 212. For example, the process cover 204 may comprise a disk section 204A and an actuator section 204B that are positioned on the process cover 204 above where the magnetic recording media and actuator pivot bearing are positioned, respectively. The disk section 204A and the actuator section 204B may extend substantially coplanar with each other and define an uppermost portion of the process cover 204.

The process cover 204 may also comprise an ECM section 204C that is configured to at least partially house an ECM 215 enclosed within a casing 217, which will be described in more detail in relation to FIG. 3. In certain embodiments (and as shown in FIG. 3), the ECM section 204C is positioned adjacent a corner of the process cover 204. For example, if the process cover 204 was split into four separate quadrants—each covering an equal amount of surface area as the other quadrants and each defining one of the corners of the process cover 204—the ECM section 204C would be fully positioned within one of the quadrants. In certain embodiments, the ECM section 204C is positioned between an outer perimeter of the process cover 204 and the actuator section 204B of the process cover 204. It should be appreciated, however, that the ECM section 204C may be positioned on the process cover 204 in other locations.

The ECM section 204C may be a recess projecting downward or away from the uppermost surface of the process cover 204. The ECM section 204C may have an upper surface profile that is configured to support a lower surface of at least a portion of the ECM 215. It should be appreciated, however, that various shapes of the ECM section 204C may be employed to at least partially house an ECM 215.

In certain embodiments, the process cover 204 comprises steel (e.g., stainless steel) and may be stamped to form the various features (e.g., the ECM section 204C) of the process cover 204. Other methods of manufacturing the process cover 204, such as machining and hydroforming, may be used.

Turning to FIG. 3, a partial side sectional schematic view of the hard disk drive 200 is shown. FIG. 3 shows the relative arrangement of the base deck 202, process cover 204, final cover 206, and ECM 215. It should be noted that the dimensions of the hard disk drive 200 as illustrated in FIG. 3 are not to scale. For simplicity, a single upper plane 204U is shown as defining the uppermost surface of the process cover 204 (e.g., the surface that is positioned closest to the final cover 206).

In certain embodiments, the ECM section 204C of the process cover 204 is tub shaped. In other words, the ECM section 204C can include one or more sidewalls 220 and a bottom surface 222 that collectively define a tub in which the ECM 215 is at least partially positioned within. In certain embodiments, the sidewall 220 is a single, continuous sidewall. The bottom surface 222 may extend substantially planar to define a lower plane 204L. It should be noted, however, that the bottom surface 222 may be shaped to include curves or other features such that the bottom surface 222 is not completely flat along the lower plane 204L. In certain embodiments, the lower plane 204L defines the lowermost surface of the process cover 204 (e.g., the surface that is closest to the bottom portion 210 of the base deck 202). The upper plane 204U and lower plane 204L may be vertically spaced apart by a distance defining a length of the sidewall 220. In certain embodiments, the sidewall 220 may include an inward taper (as shown in FIG. 3). In other embodiments, the sidewall 220 may be perpendicular with the upper and lower planes 204U, 204L. In yet other embodiments, the ECM section 204C may comprise any suitable retention or support feature formed in the process cover 204, including pockets, shelves, ledges, partial recesses, or combinations thereof, and is not limited to a fully tub shaped geometry.

As previously discussed, the ECM 215 includes one or more environmental control components that are configured to manage environmental conditions (e.g., humidity, chemical contaminant concentration, oxygen levels) within the hard disk drive 200. For example, the ECM 215 may include a desiccant package 218 comprising a desiccant material therein. The desiccant package 218 assists in humidity control within the hard disk drive 200. More specifically, the desiccant material is configured to remove water vapor (e.g., by absorption) to reduce humidity within the hard disk drive 200. In certain embodiments, the desiccant material consists of silica gel. In other embodiments, the desiccant material consists of zeolite desiccants, such as zeolite 4A or zeolite 13X.

Plastic materials may harbor moisture and chemical contaminants, which can potentially affect the hard disk drive 200. Plastic materials may also absorb oxygen, reducing the overall oxygen level in the hard disk drive 200. As such, in some embodiments, the outermost surfaces of the desiccant package 218 do not include plastic or includes essentially no plastic. In some embodiments, limited amounts of plastic may be present, provided that overall outgassing impact is limited or reduced.

Because the desiccant material is configured to absorb moisture once exposed to a humid environment, the ECM 215 (or at least the desiccant positioned therein) can be kept in a dry environment while the hard disk drive 200 is assembled. One approach for maintaining exposure to a dry environment is by enclosing or surrounding the desiccant with a casing 217. The casing 217 may be directly supported by the ECM section 204C. The casing 217 may be configured to reduce the risk of unwanted moisture ingress into the ECM 215 prior to assembly of the hard disk drive. For example, the casing 217 can help prevent moisture from reaching the desiccant until the casing 217 is punctured as part of the assembly process. After the casing 217 is punctured, moisture can be allowed to reach the desiccant.

In some embodiments, the casing 217 is a housing. For example, the casing 217 may comprise a metal. More specifically, the casing 217 may be a metallic foil. In some embodiments, the casing 217 includes a metallized plastic (e.g., a plastic film coupled to a metal layer such as aluminum), expanded polytetrafluoroethylene (ePTFE), or thin plastic sheet or film that has some plastic but has an overall low mass. In certain embodiments, the casing 217 does not include plastic or includes essentially no plastic. The material and structure (e.g., thickness) of the casing 217 can be selected such that the casing 217 is deformable such that casing 217 can deform to match a shape of the ECM section 204C of the process cover 204. In other embodiments, the casing 217 is rigid and shaped to match the ECM section 204C.

The casing 217 is substantially positioned within the second internal cavity 216 (e.g., between the final cover 206 and at least a portion of the process cover 204). In certain embodiments, a portion of the casing 217 is positioned between lower and upper planes 204L, 204U of the process cover 204. In certain embodiments, a top surface of the casing 217 is parallel with the upper plane 204U of the process cover 204. In some instances, the top surface of the casing 217 may additionally be coplanar with the upper plane 204U of the process cover 204. In certain embodiments, the casing 217 includes outer surfaces that directly contact the process cover 204 (more specifically, the ECM section 204C of the process cover 204).

The ECM 215 may include other environmental control components. For example, in some embodiments, the ECM 215 includes a filter 219 to assist in chemical contamination control. For example, the filter 219 may be configured to remove plastic within internal cavities. The filter 219 may be a carbon filter. Carbon filters comprise carbon molecules that, upon activation, undergo an adsorption process to remove certain volatile organic compounds and vapors. Other filters may be implemented alone or in addition to filter 219.

In some embodiments, the filter 219 is positioned within the second internal cavity 216 (e.g., in the ECM section 204C or otherwise in proximity with the ECM 215). Optionally, a filter 226 may be positioned within the first internal cavity 212 (e.g., separate and spaced from the ECM 215 and instead in proximity with the data storage components 214). In some embodiments, the hard disk drive 200 may have a first filter 219 positioned within the ECM 215 and a second filter 226 positioned within the first internal cavity 212.

The process cover 204 may include one or more holes 224 that allow fluid communication between the first internal cavity 212 and the second internal cavity 216. More specifically, the ECM section 204C may include the one or more holes 224, enabling the ECM 215 to assist in controlling the environment of the first internal cavity 212 using the approaches described herein.

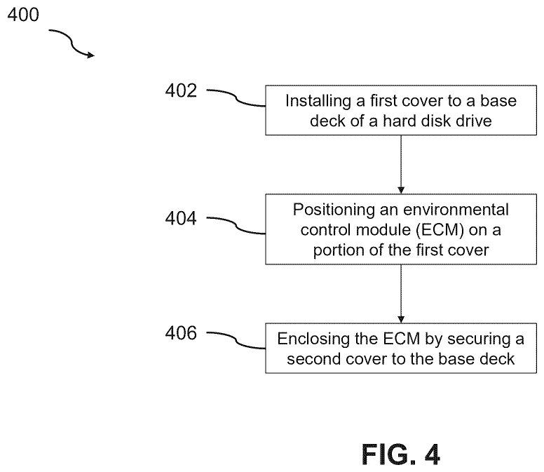

FIG. 4 is a flowchart showing a method 400 of assembling the hard disk drive 200, in accordance with certain embodiments of the present disclosure.

The method 400 includes coupling the process cover 204 to the base deck 202 of a hard disk drive 200 (“Step 402”). The process cover 204 may be coupled to the base deck 202 by removable fasteners (e.g., screws). As previously discussed, the base deck 202 may additionally include gaskets 220 to facilitate coupling and sealing of the process cover 204 to the base deck 202.

In certain embodiments, the method 400 further includes positioning the ECM 215 on a portion of the process cover 204 (“Step 404”). In certain embodiments, positioning the ECM 215 comprises positioning the ECM 215 in a tub (e.g., ECM section 204C) formed by the process cover 204.

In certain embodiments, the method 400 further includes enclosing the ECM 215 by securing the final cover 206 to the base deck 202 (“Step 406”). In certain embodiments, securing the final cover 206 to the base deck 202 comprises welding (e.g., friction stir welding, laser welding) the final cover 206 to the base deck 202. Once the final cover 206 is coupled to the base deck 202, the second internal cavity 215 is defined therein.

Various additions, removals, or modifications to the steps of method 400 as discussed herein may be contemplated. For example, the method 400 may further comprise piercing/puncturing/tearing/peeling the casing 217 of the ECM 215 before the enclosing step 406. More specifically, in embodiments where the desiccant material is housed within the casing 217, the casing 217 is selectively pierced/punctured/torn/peeled so as to allow moisture to reach the desiccant material in the ECM 215. In some embodiments, a punch tool is used to pierce the casing 217. The punch tool can be machine-driven or manually-driven.

Once the desiccant material is exposed to moisture within the hard disk drive, the desiccant material can cause a reduction in a humidity of an internal cavity of the hard disk drive.

Various modifications and additions can be made to the embodiments disclosed without departing from the scope of this disclosure. For example, while the embodiments described above refer to particular features, the scope of this disclosure also includes embodiments having different combinations of features and embodiments that do not include all of the described features.

We claim:

1. A hard disk drive comprising:
a base deck;
a first cover coupled to the base deck;
a second cover coupled to the base deck; and
an environmental control module (ECM) positioned between the second cover and at least a portion of the first cover.

2. The hard disk drive of claim 1, wherein the ECM comprises a desiccant.

3. The hard disk drive of claim 2, wherein the desiccant is positioned within a housing that is supported by the first cover.

4. The hard disk drive of claim 3, wherein the housing does not include a plastic material.

5. The hard disk drive of claim 3, wherein the housing comprises a metal.

6. The hard disk drive of claim 5, wherein the housing is a metallic foil.

7. The hard disk drive of claim 1, wherein the first cover comprises an ECM portion.

8. The hard disk drive of claim 7, wherein the ECM portion is tub-shaped and is configured to support the ECM.

9. The hard disk drive of claim 7, wherein the ECM portion includes an opening such that the ECM is in fluid communication with a first internal cavity of the hard disk drive.

10. The hard disk drive of claim 9, wherein the first internal cavity is formed by the first cover and a sidewall and bottom portion of the base deck.

11. The hard disk drive of claim 10, wherein the base deck further comprises a plurality of data storage components positioned within the first internal cavity.

12. The hard disk drive of claim 11, wherein the plurality of data storage components comprises at least one of: magnetic recording media, a spindle motor, an actuator pivot bearing, a suspension element, and a plurality of read/write heads.

13. The hard disk drive of claim 1, wherein the first cover includes a top surface, wherein the second cover includes a bottom surface, wherein the ECM is positioned between the top surface and the bottom surface.

14. The hard disk drive of claim 13, wherein the second cover is welded to the base deck.

15. The hard disk drive of claim 1, wherein the ECM comprises a desiccant and a carbon filter.

16. A method comprising:
coupling a first cover to a base deck of a hard disk drive;
positioning an environmental control module (ECM) on a portion of the first cover; and
enclosing the ECM by securing a second cover to the base deck.

17. The method of claim 16, further comprising: piercing an exterior surface of the ECM before the enclosing.

18. The method of claim 16, wherein the positioning the ECM comprises positioning the ECM in a tub formed by the first cover.

19. The method of claim 16, wherein the securing comprises welding.

20. The method of claim 16, further comprising: reducing, using the ECM, a humidity of an internal cavity of the hard disk drive after the enclosing.
